(19) United States
(12) Patent Application Publication
(10) Pub. No.: US 2013/0113438 A1
(43) Pub. Date: May 9, 2013

(54) Power Tool

(71) Applicant: Hitachi Koki Co., Ltd., Tokyo (JP)

(72) Inventors: Takao Aradachi, Ibaraki (JP); Tomomasa Nishikawa, Ibaraki (JP); Yuki Nitanai, Ibaraki (JP)

(73) Assignee: HITACHI KOKI CO., LTD., Tokyo (JP)

(21) Appl. No.: 13/661,688

(22) Filed: Oct. 26, 2012

(30) Foreign Application Priority Data
Oct. 31, 2011 (JP) 2011-238790

(51) Int. Cl. H02K 7/14

(52) U.S. Cl. 320/162; 310/50; 318/139

(57) ABSTRACT

A power tool including: a motor configured to be rotated by a lithium-ion secondary battery; an end tool configured to be driven by the rotation of the motor; and a switch configured to cause power to be supplied from the lithium-ion secondary battery to the motor when being manipulated by an operator, wherein the lithium-ion secondary battery includes a cell having a 14500 size and is configured to rotate the motor such that an output of the motor is sufficient for driving the end tool.

### CROSS-REFERENCE TO RELATED APPLICATIONS

This application claims priority from Japanese Patent Application No. 2011-238790 filed on Oct. 31, 2011, the entire contents of which are incorporated herein by reference.

### TECHNICAL FIELD

The present invention relates to a cordless power tool having a motor which is driven by a lithium-ion secondary battery, and is particularly for further reducing size and weight of a power tool.

### BACKGROUND

As for power tools, an increase in capacity and a reduction in weight have been requested with respect to batteries for driving cordless tools. With respect to this request, lithium-ion secondary batteries having high output densities have been used. As an example of a product using the lithium-ion secondary batteries, there have been a known product having a plurality of cells and a protection circuit configured in a battery pack form as a driving source for a power tool and capable of being attached to or detached from a main body of a power tool, as disclosed in JP-A-2006-294310. The present invention relates to a cordless power tool having a motor which is driven by a lithium-ion secondary battery, and is particularly for further reducing size and weight of a power tool.

### SUMMARY

Lithium-ion secondary battery cells capable of being used as driving sources for the power tools have mainly cells having an 18650 size. In general, according to the voltages or capacities of batteries, cells having the 18650 size are connected in series or in parallel. Power tools using lithium-ion battery cells having the 18650 size have smaller sizes and weights as compared to cases of using a nickel-cadmium battery or a nickel-hydrogen battery. However, for example, in order to implement power tools to be used for very light work by children, women, and elderly people, it is required to further reduce sizes and weights thereof. Also, it is required to further reduce the sizes and weights of power tools while keeping the same motor powers as those of power tools currently on the market.

The present invention was made in view of the above-mentioned circumferences, and an object of the present invention is to implement a power tool using a small and light lithium-ion battery having the 14500 size.

Another object of the present invention is to provide a compact power tool in which a lithium-ion battery having the 14500 size is disposed inside a grip portion such that a weight balance is good and a battery mounting portion does not protrude from an end of the grip portion.

A further object of the present invention is to provide a power tool to which a battery pack can be mounted compactly by devising a method of disposing the battery packs using a plurality of lithium-ion batteries having the 14500 size.

Representative features of the invention to be disclosed in this application are as follows.

According to an aspect of the present invention, there is provided a power tool including: a motor configured to be rotated by a lithium-ion secondary battery; an end tool configured to be driven by the rotation of the motor; and a switch configured to cause power to be supplied from the lithium-ion secondary battery to the motor when being manipulated by an operator, wherein the lithium-ion secondary battery includes a cell having a 14500 size and is configured to rotate the motor such that an output of the motor is sufficient for driving the end tool.

Since the lithium-ion secondary battery includes a cell having the 14500 size and is configured to rotate the motor such that an output of the motor is sufficient for driving the end tool, it is possible to provide a small and light power tool using a small and light lithium-ion battery to a user.

According to another aspect of the present invention, there is provided a power tool including: a housing; a lithium-ion secondary battery accommodated in the housing; a motor configured to be rotated by the lithium-ion secondary battery; an end tool configured to be driven by the rotation of the motor; and a switch configured to cause power to be supplied from the lithium-ion secondary battery to the motor when being manipulated by an operator, wherein the lithium-ion secondary battery includes a cell having a 14500 size and is configured to rotate the motor such that an output of the motor is sufficient for driving the end tool.

In the power tool using the lithium-ion secondary battery as a power supply, since the cell having the 14500 size is accommodated inside the housing, it is possible to prevent the battery accommodating portion from protruding to the outside of the housing and to implement a small and user-friendly power tool having a refined appearance.

According to another aspect of the present invention, there is provided a power tool including: a housing; a motor configured to be rotated by a lithium-ion secondary battery; an end tool configured to be driven by the rotation of the motor; and a switch configured to cause power to be supplied from the lithium-ion secondary battery to the motor when being manipulated by an operator; wherein the lithium-ion secondary battery includes a cell having a 14500 size and is configured to rotate the motor such that an output of the motor is sufficient for driving the end tool, and wherein the lithium-ion secondary battery is configured in a battery pack which is attachable to and detachable from the housing of the power tool.

Since the power tool includes the battery pack including a cell having the 14500 size, it is possible to implement a small and light power tool having a very compact battery pack.

The above and other objects and new features of the present invention will become apparent from the following description of this specification and the drawings.

### BRIEF DESCRIPTION OF DRAWINGS

FIGS. 1A and 1B are views illustrating the dimensions of lithium-ion batteries for power tools;

FIG. 2 is a longitudinal sectional view illustrating a configuration of a power tool (impact driver) according to a first exemplary embodiment of the present invention;

FIG. 3 is a longitudinal sectional view illustrating a configuration of a power tool (jigsaw) according to a second exemplary embodiment of the present invention;

FIG. 4 is a longitudinal sectional view illustrating a configuration of a power tool (jigsaw) according to a third exemplary embodiment of the present invention;

FIG. 5 is a longitudinal sectional view illustrating a configuration of a power tool (disc grinder) according to a fourth exemplary embodiment of the present invention;

FIG. 6 is a circuit block diagram illustrating the power tools according to the first to fourth exemplary embodiments of the present invention;

FIG. 7 is a longitudinal sectional view illustrating a configuration of a power tool (impact driver) according to a fifth exemplary embodiment of the present invention;

FIG. 8 is a longitudinal sectional view illustrating a configuration of a power tool (jigsaw) according to a sixth exemplary embodiment of the present invention; and

FIG. 9 is a circuit block diagram illustrating the power tools according to the fifth and sixth exemplary embodiments of the present invention.

### DETAILED DESCRIPTION

Hereinafter, exemplary embodiments of the present invention will be described with reference to the accompanying drawings. In this specification, a front side, a rear side, an upper side, and a lower side will be described with reference to directions shown in each drawing.

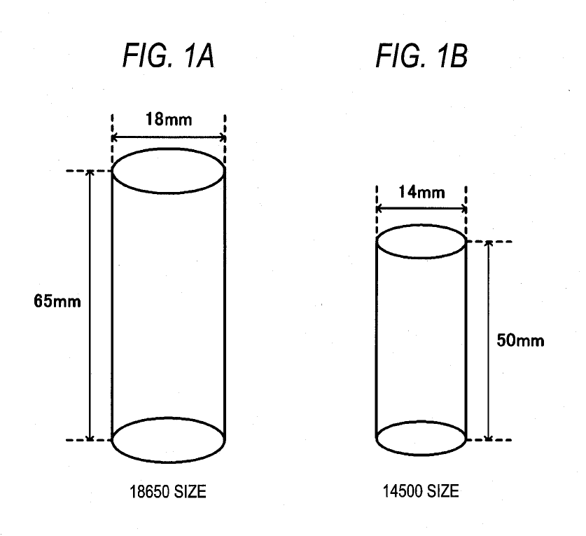

FIGS. 1A and 1B are views illustrating the dimensions of lithium-ion batteries for power tools. Specifically, FIG. 1A illustrates a size having been generally used, and FIG. 1B illustrates a size to be used in the present invention. Lithium-ion secondary batteries (hereinafter, referred to as ‘lithium-ion batteries’) are one kind of secondary batteries currently on the market. Since lithium ions included in an electrolyte take the roll of electrical conduction, the lithium-ion secondary batteries are characterized by higher capacity per density as compared to general nickel-hydrogen batteries. Referring to FIG. 1A, lithium-ion batteries having been widely used have a cylindrical shape having a diameter of 18 mm and a height of 65 mm, and this size is called as a 18650 size. Here, in the number ‘18650’, the first two digits ‘18’ represent the diameter and the next three digits'650′ represent the length (in a unit of 0.1 mm) FIG. 1B illustrates the size of a cylindrical lithium-ion battery for a power tool according to the present invention, where the diameter is 14 mm and the height is 50 mm This size is almost the same as a so-called size R6 or AA of dry-cell batteries (primary batteries).

### First Exemplary Embodiment

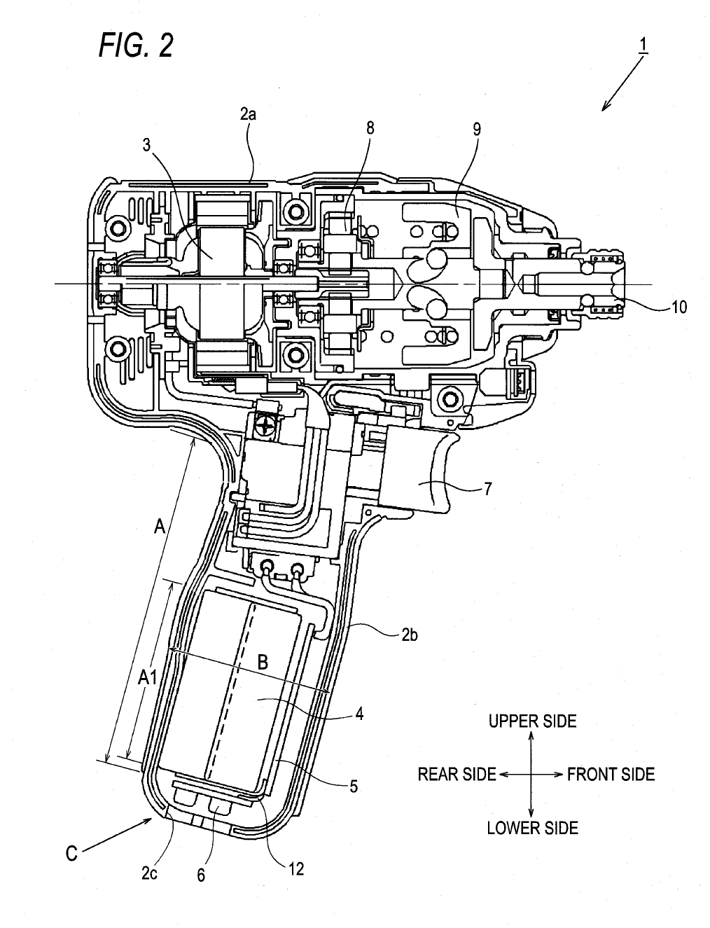

FIG. 2 is a longitudinal sectional view illustrating a configuration of a power tool (impact driver 1) according to a first exemplary embodiment of the present invention. A housing 2 of the impact driver 1 is composed of a cylindrical body portion 2a and a grip portion 2b. In the body portion 2a, a motor 3, a gear unit 8, and a striking unit 9 are coaxially accommodated, and an end tool (not shown) is mounted on an output shaft 10 at the fore end of the body portion 2a. The grip portion 2b is provided to extend obliquely downward from the vicinity of the center of the lower side of the body portion 2a, and an operator grasps the grip portion 2b with the right hand (or left hand), thereby holding the impact driver 1. In the vicinity of an upper portion of the grip portion 2b which is a root attached to the body portion 2a, a trigger switch 7 is provided to protrude in the front direction.

In the impact driver 1 of the present exemplary embodiment, inside the grip portion 2b, three lithium-ion batteries 4 having the 14500 size, a protection circuit board 5 for monitoring charging and discharging of the lithium-ion batteries 4 and protecting the lithium-ion batteries 4, and a socket 6 for connecting the protection circuit board 5 and an external charging apparatus (not shown) are accommodated. The protection circuit board 5 is disposed at an outer side the lithium-ion batteries 4 in a radial direction of the lithium-ion batteries 4. Further, the protection circuit board 5 is disposed substantially parallel to the lithium-ion batteries 4. The socket 6 is disposed lower to the lithium-ion batteries 4. A width of the socket 6 is shorter than a length of the lithium-ion batteries 4 in a radial direction thereof. At the lower portion of the grip portion 2b, a through-hole 2c is provided for inserting a connector (not shown) extending from the external charging apparatus (not shown) into the socket 6. Also, although not shown, a rubber cap or the like may be provided for closing the through-hole 2c when the connector is not inserted in the socket 6. In the present exemplary embodiment, the diameter (outside diameter) B of a portion of the grip portion 2b for accommodating the lithium-ion batteries 4 is about 34 mm. It is preferable to set the diameter B of the grip portion 2b to about 30 mm to 40 mm, for instance. The operator grasps the grip portion 2b within a range shown by an arrow ‘A’ with one hand. A length in an axis direction which is occupied by the lithium-ion batteries 4 is A1, and the lithium-ion batteries 4 are disposed such that the length A1 is completely within the range having the length A. Therefore, it is possible to implement the impact driver 1 having a refined appearance without providing a portion thicker than the diameter B of the grip portion 2b at the vicinity of a lower end portion C of the grip portion 2b. A length of the protection circuit board 5 is shorter than the length A1.

The socket 6 has, for example, five terminals, and the terminals are connected to the protection circuit board 5 by lead wires 12. The lithium-ion batteries 4 of the present exemplary embodiment have a small size called the 14500 size, and have output characteristics capable of sufficiently driving the power tool. For example, in the present exemplary embodiment, it is possible to obtain sufficient motor power by the lithium-ion batteries 4. As described above, according to the present exemplary embodiment, it is possible to implement the power tool by using the small and light lithium-ion batteries 4 capable of driving the motor with a necessary and sufficient output. Therefore, it is possible to implement a user-friendly, small, and light power tool.

### Second Exemplary Embodiment

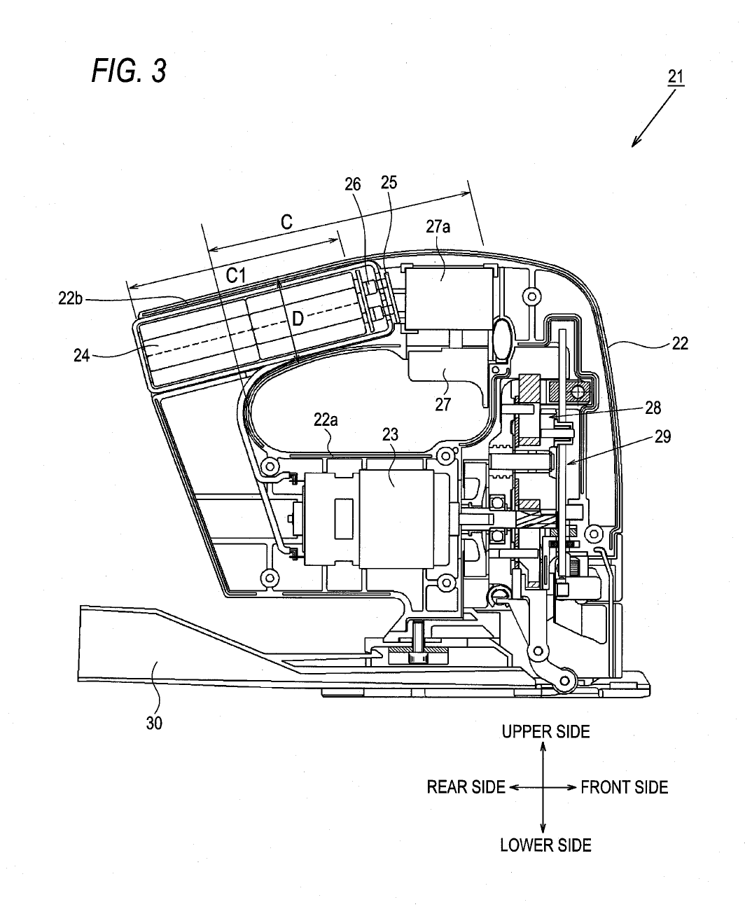

FIG. 3 is a longitudinal sectional view illustrating a configuration of a power tool (jigsaw 21) according to a second exemplary embodiment of the present invention. The jigsaw 21 is configured such that a motor 23 serving as a driving source and a rotating mechanism unit 28 for converting rotation of the motor 23 into reciprocating movement of a reciprocating mechanism unit 29 are included inside a housing 22. At the lower end of the reciprocating mechanism unit 29, an end tool such as a blade (not shown) is mounted. As shown in FIG. 3, the housing 22 has a substantially annular shape in a side view. The upper portion of the housing 22 becomes a grip portion 22b for allowing an operator to grasp it with the right hand or the left hand, and the lower portion of the housing 22 becomes a motor accommodating portion 22a for accommodating the motor 23. The motor accommodating portion 22a and the grip portion 22b of the housing 22 are connected at the front side, and in the connection portion, the rotating mechanism unit 28 is accommodated. On the front lower side of the housing 22, a base 30 to be a guide member during a cutting operation is attached.

On the front lower side of the grip portion 22b, a trigger switch 27 that causes the tool to be operated when being manipulated by the operator is provided. In the present exemplary embodiment, the grip portion 22b corresponds to a portion having a length C, and six lithium-ion batteries 24 having the 14500 size are provided to partially overlap the inner side of the grip portion 22b. The lithium-ion batteries 24 are divided into groups of three series-connected batteries and the groups are connected in parallel, whereby one battery set is formed. Therefore, it is possible to obtain a sufficient output for driving the power tool by using a small battery.

A length in a front/rear direction occupied by the lithium-ion batteries 24 is C1. In the present exemplary embodiment, the lithium-ion batteries 24 are disposed such that most (half or more) of the length C1 of the lithium-ion batteries 24 overlaps the length C of the grip portion 22b. Also, on the front side of the battery set of the lithium-ion batteries 24, between a trigger switch unit 27a and the battery set, a protection circuit board 25 for monitoring charging and discharging of the lithium-ion batteries 24 and protecting the lithium-ion batteries 24 is disposed. The protection circuit board 25 is disposed at an extension of the lithium-ion batteries 24 in a longitudinal direction thereof. A length of the protection circuit board 25 is shorter than a length of the lithium-ion batteries 24 in a radial direction thereof. In the vicinity of the protection circuit board 25, a socket 26 to which an external charging apparatus (not shown) can be connected provided.

If a jigsaw is configured like the jigsaw of the present exemplary embodiment, it is possible to effectively accommodate batteries inside the grip portion 22b such that the batteries do not protrude outward from the housing 22. Therefore, it is possible to implement a compact and light jigsaw 21 having a refined appearance.

### Third Exemplary Embodiment

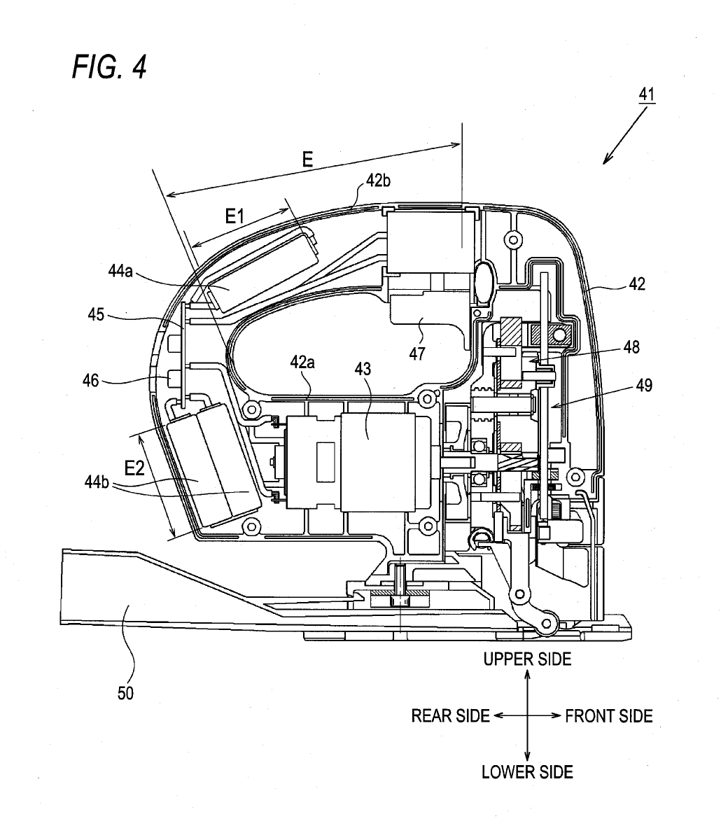

FIG. 4 is a longitudinal sectional view illustrating a configuration of a power tool (jigsaw 41) according to a third exemplary embodiment of the present invention. In the third exemplary embodiment, a basic configuration is the same as that shown in FIG. 3, but the total number of batteries to be used is reduced to 3 and a plurality of lithium-ion batteries are disposed at separate positions. In other words, one lithium-ion battery 44a is accommodated inside a grip portion 42b, and two lithium-ion batteries 44b are accommodated at the rear side of a motor 43. The length of the lithium-ion battery 44a in the front/rear direction is E1, and the lithium-ion battery 44a is disposed to be inside the range of the length E of the grip portion 42b. Also, the two lithium-ion batteries 44b are disposed in the vicinity of the rear end of a motor accommodating portion 42a of a housing 42, and the length in the longitudinal direction occupied by the lithium-ion batteries 44b is E2. Between the lithium-ion battery 44a and the lithium-ion batteries 44b, in the vicinity of the rear end of the housing 42, a protection circuit board 45 and a socket 46 to which a connector (not shown) extending from an external charging apparatus (not shown) can be mounted are disposed.

In the present exemplary embodiment, all of the plurality of batteries are disposed to be inside the housing 42 having roughly an annular shape or a doughnut shape in a side view, and the lithium-ion battery 44a is disposed to be inside the grip portion 42b. Further, the lithium-ion batteries 44a and 44b are distributed to the upper side and the lower side, and the protection circuit board 45 is disposed therebetween. In this case, in the vertical direction, the upper battery (the lithium-ion battery 44a) is set to be lighter (less) than the lower batteries (the lithium-ion batteries 44b). As a result, it is possible to distribute relatively heavy batteries to the grip portion 42b and a portion close to the motor 43, and to implement a light and user-friendly jigsaw having a low center of gravity. Also, it is possible to arbitrarily dispose lithium-ion batteries 44 inside the housing 42 according to the shape of a required power tool.

### Fourth Exemplary Embodiment

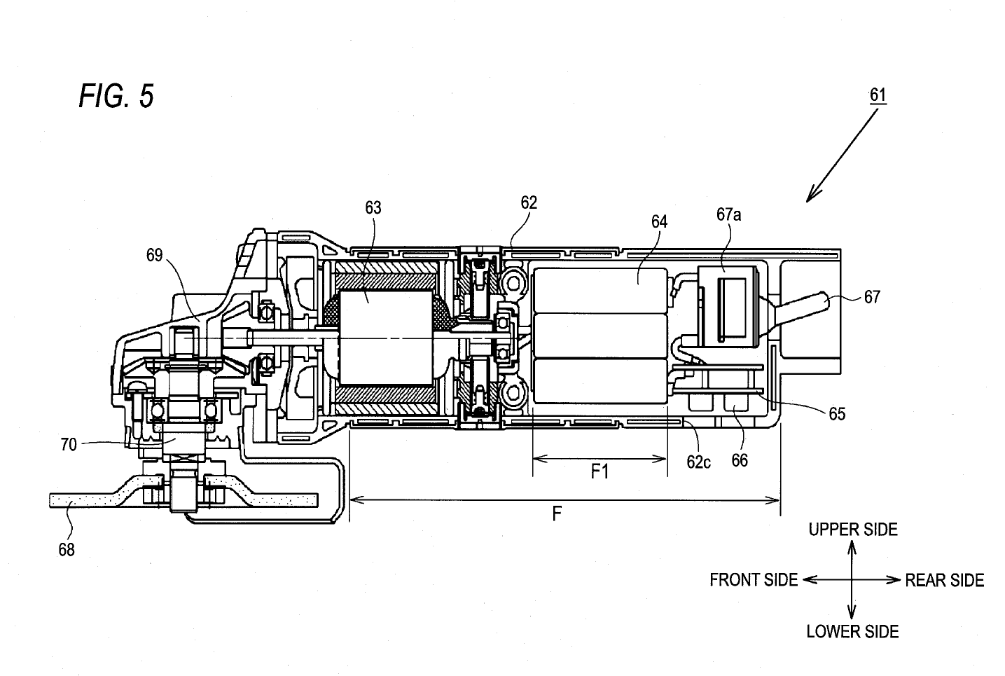

Now, a fourth exemplary embodiment of the present invention will be described with reference to FIG. 5. FIG. 5 is a longitudinal sectional view illustrating a configuration of a disc grinder 61 as a power tool. In the disc grinder 61, six lithium-ion batteries 64, a motor 63 for rotating a rotary tool 68, and a switch unit 67a for turning on or off the motor 63 are accommodated inside a cylindrical housing 62. At the end of the housing 62, a gear unit 69 for converting a rotation axis direction by 90 degrees is provided, and at the lower fore end of a spindle 70, the rotary tool 68 such as a grindstone is mounted. If an operator swings a switch lever 67 to be in an ON state, the motor 63 rotates and thus the rotary tool 68 rotates at a predetermined rotating speed.

The lithium-ion batteries 64 to be accommodated in the housing 62 are six batteries having the 14500 size, and are disposed between the motor 63 and the switch unit 67a in the vicinity of a substantial center of the housing 62. In this type of disc grinder 61, almost the entire housing is a grip portion whose length becomes about F. As seen in the axis direction (the longitudinal direction or the front/rear direction), the lithium-ion batteries 64 are disposed at a portion having a length F1 completely included in the grip portion. On the rear lower side of the batteries, below the switch unit 67a, a protection circuit board 65 and a socket 66 to which a connector (not shown) extending from an external charging apparatus (not shown) can be mounted are disposed. The protection circuit board 65 is disposed substantially parallel to the lithium-ion batteries 64. The switch unit 67a is disposed at an extension of the lithium-ion batteries 64 in a longitudinal direction thereof and overlaps with the protection circuit board 65 in a radial direction of the lithium-ion batteries 64. Although only two terminals are shown in FIG. 5, actually, the socket 66 may have about five terminals. At the housing 62 in the vicinity of the socket 66, a through-hole 62c is provided for inserting the connector (not shown) extending from the external charging apparatus into the socket. Although a cover is not provided for the through-hole 62c in FIG. 5, a rubber cap or the like may be provided.

According to the disc grinder 61 configured as described above, it is possible to provide a compact, small, and user-friendly power tool having a small full length and a thin grip portion.

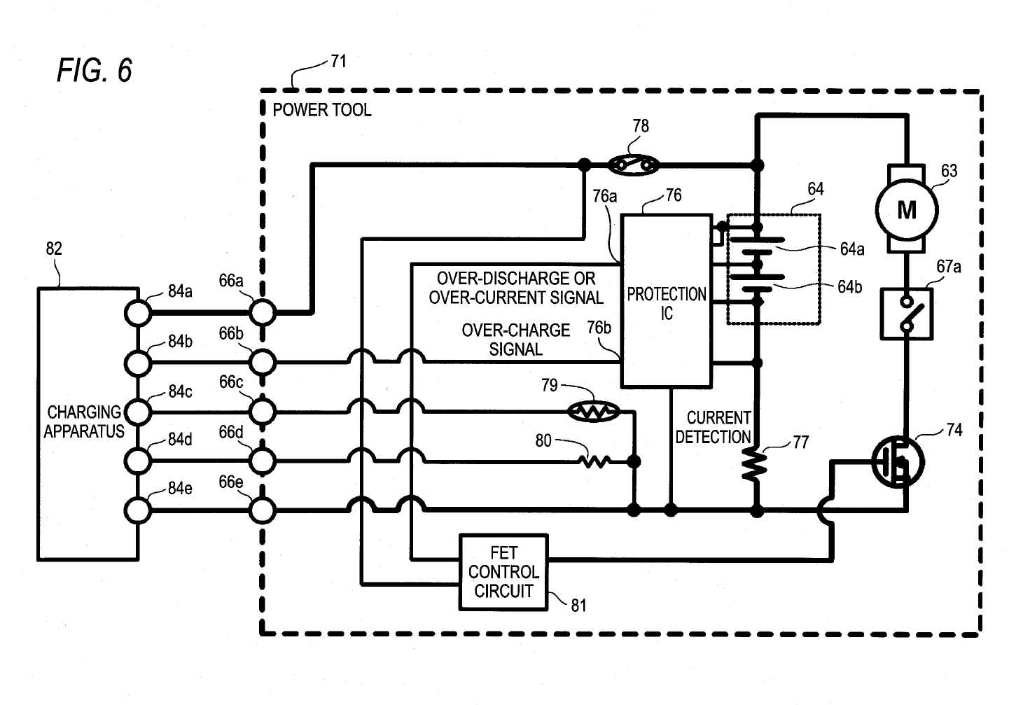

Now, a circuit block diagram regarding the power tools according to the first to fourth exemplary embodiments will be described with reference to FIG. 6. In FIG. 6, a charging apparatus 82 for charging the lithium-ion batteries 4 is also shown. The charging apparatus 82 is configured to be attachable to and detachable from a main body of a power tool 71 (such as the impact driver 1 or the jigsaw 21 or 41). If charging is necessary, the charging apparatus 82 is connected to the power tool 71, and charging is performed, and if the power tool 71 is being used for an operation or a case where charging is not necessary, a connector (not shown) of the charging apparatus 82 can be removed from the power tool 71.

Inside the power tool 71, lithium-ion batteries, a protection circuit, and the like are provided. The motor 63 is a driving unit which is built in the main body of the power tool 71. The operator manipulates the switch unit 67a, thereby rotating the motor 63. In the fourth exemplary embodiment, the switch unit 67a is configured by a swing switch for turning on or off the power tool. However, in the first to third exemplary embodiments, the trigger switches 7, 27, and 47 corresponding to the switch unit 67a are configured by variable resistors. If the trigger switch 7, 27, or 47 which is a variable resistor is used, the rotating speed of the motor 63 changes according to the amount of pulling of the trigger switch. An FET 74 is disposed between the switch unit 67a and the negative electrode of a battery set 64, and is normally in an ON state. If the operator turns on the switch unit 67a, a battery set 64 is connected to the motor 63. Meanwhile, if the battery set 64 is in an over-discharge, over-current, or high temperature state, the FET 74 is turned off, such that the connection between the battery set 64 and the motor 63 is cut.

The battery set 64 is composed of two lithium-ion batteries 64a and 64b. In the present exemplary embodiment, the battery set 64 is configured by connecting two cells of the lithium-ion batteries 64a and 64b in series. However, the present invention is not limited to this form. For example, one, or three or more lithium-ion batteries may be connected in series. Also, in addition to series connection, cells may be connected in parallel (for example, one or more groups of sets of two parallel-connected cells are connected in series). The state of the battery set 64 is monitored by a protection IC 76. The protection IC 76 is an integrated circuit having multiple functions of a battery-voltage detecting unit for detecting a voltage which is supplied from the battery set 64 to the motor 63, a battery-voltage detecting unit for detecting the voltage of the battery set 64 during charging, and a current detecting unit for detecting a current which is supplied from the battery set 64 to the motor 63.

A shunt resistor 77 is connected in series to an intermediate position of a wire from the motor 63 to the battery set 64 such that the voltage between both ends of the shunt resistor 77 is input to the protection IC 76. Therefore, the protection IC 76 can measure a current flowing in the motor 63. In a normal state, the protection IC 76 outputs a voltage corresponding to the battery voltage from an output terminal 76a, and in an over-discharge or over-current state, the protection IC 76 does not output the signal. In response to this signal, a FET control circuit 81 can output a gate signal to the FET 74, thereby performing control. The protection IC 76 detects a voltage drop by a current flowing in the shunt resistor 77 (a voltage drop proportional to the current), and if the voltage drop is a predetermined value or more (the flowing current is a predetermined value or more), the protection IC 76 outputs a signal corresponding to the over-current state (hereinafter, referred to as an ‘over-current signal’) from the output terminal 76a to the FET control circuit 81. Also, the protection IC 76 detects the battery voltage of each cell of the battery set 64, and if the battery voltage of at least one of the plurality of cells 64a and 64b is the predetermined voltage or more, the protection IC 76 does not output the voltage corresponding to the battery voltage from the output terminal 76a to the FET control circuit 81.

When the battery set 64 is being charged using the charging apparatus 82, the protection IC 76 acts to monitor a charging state, and detects the battery voltage of each cell of the battery set 64. Then, if the battery voltage of at least one of the plurality of cells 64a and 64b is a predetermined voltage or more, the protection IC 76 outputs a signal (hereinafter, referred to as an ‘over-charge signal’) from the output terminal 76a to the charging apparatus 82. If receiving this signal, the charging apparatus 82 stops the charging. A thermal protector 78 is a switch which is turned off if a temperature becomes a predetermined value or more, and is turned on if the temperature becomes a predetermined value or less. The thermal protector 78 is disposed in the vicinity of the battery set 64, and is turned on or off according to the temperature of the batteries during discharging or charging. During the operation of the power tool 71 (discharging of the batteries), if the battery temperature becomes a high temperature, the voltage corresponding to the battery voltage is not input from the output terminal 76a to the FET control circuit 81, the FET 74 is turned off. During charging, if the temperature of the battery set 64 rises and exceeds an allowable value, the thermal protector 78 operates to cut the connection between the battery set 64 and the charging apparatus 82. Meanwhile, even in a state where the temperature of the battery set 64 does not rise up to the allowable value, a thermistor 79 is used to feed the temperature information to the charging apparatus 82. The resistance value of thermistor 79 changes according to the temperature, and thus the thermistor 79 is disposed in the vicinity of the battery set 64. One terminal of the thermistor 79 is connected to the charging apparatus 82 through terminals 66c and 84c. A determining resistor 80 is provided for determining the voltage of the battery set 64 (for example, whether two cells have been connected or three cells have been connected), and the output of the determining resistor 80 is transmitted to the charging apparatus 82 through terminals 66d and 84d.

The FET control circuit 81 is for controlling ON or OFF of the FET 74, and the over-current signal output from the output terminal 76a of the protection IC 76 is input to the FET control circuit 81. If the over-current signal is at a high level (representing the over-current state), the FET control circuit 81 makes the gate signal of the FET 74 become a low level, thereby turning off the FET 74. Also, the signal (corresponding to the battery voltage) from the thermal protector 78 is input to the FET control circuit 81. During the operation of the power tool 71, if the battery set 64 becomes a high temperature and thus the thermal protector 78 operates, the FET control circuit 81 makes the gate signal of the FET 74 become the low level, thereby turning off the FET 74.

The charging apparatus 82 is a device which uses a commercial AC power supply to supply power for charging the batteries to the power tool 71 side. The power tool 71 has terminals 66a, 66b, 66c, 66d, and 66e, the charging apparatus 82 has terminals 84a, 84b, 84c, 84d, and 84e, and the terminals of the power tool 71 are connected to the terminals of the charging apparatus 82 by cables (not shown). The terminal 66a is connected to the plus terminal of the battery set 64 through the thermal protector 78. Also, the terminal 66a is connected to the terminal 84a of the charging apparatus 82. The terminal 66b is connected to the output terminal 76b of the protection IC 76 from which the ‘over-charge signal’ is output. The charging apparatus 82 detects the signal from the protection IC 76 through the terminals 84b and 66b, and stops supply of power for charging to the power tool 71 in a case of determining the over-charge state. The terminal 66c is connected to the thermistor 79. The charging apparatus 82 detects the value of the thermistor 79 (that is, the current battery temperature) through the terminals 84c and 66c, and adjusts a charging voltage or a charging current on the basis of the detected value (the battery temperature) (for example, if the temperature is the predetermined value or more, the charging apparatus 82 performs control such that the charging stops). The terminal 66d is connected to the determining resistor 80. The charging apparatus 82 determines the kind of the battery set 64 (the number of series-connected lithium-ion batteries) from the voltage value detected through the terminals 84d and 66d, and performs control on charging on the basis of the determined battery kind (for example, the charging apparatus 82 changes an option of a constant voltage for charging between a case of determining that the battery set is a battery set of two cells and a case of determining that the battery set is a battery set of three cells. The terminal 66e is connected to the minus terminal of the battery set 64. Also, the terminal 66e is connected to the terminal 84e of the charging apparatus 82. The charging apparatus 82 supplies charging power to the battery set 64 through the plus terminals 66a and 84a and the minus terminals 66e and 84e.

As described above, in the present exemplary embodiment, the lithium-ion batteries 64a and 64b and the protection circuit for protecting the batteries are provided in the impact driver 1. Therefore, it is possible to implement a reliable power tool which operates stably.

### Fifth Exemplary Embodiment

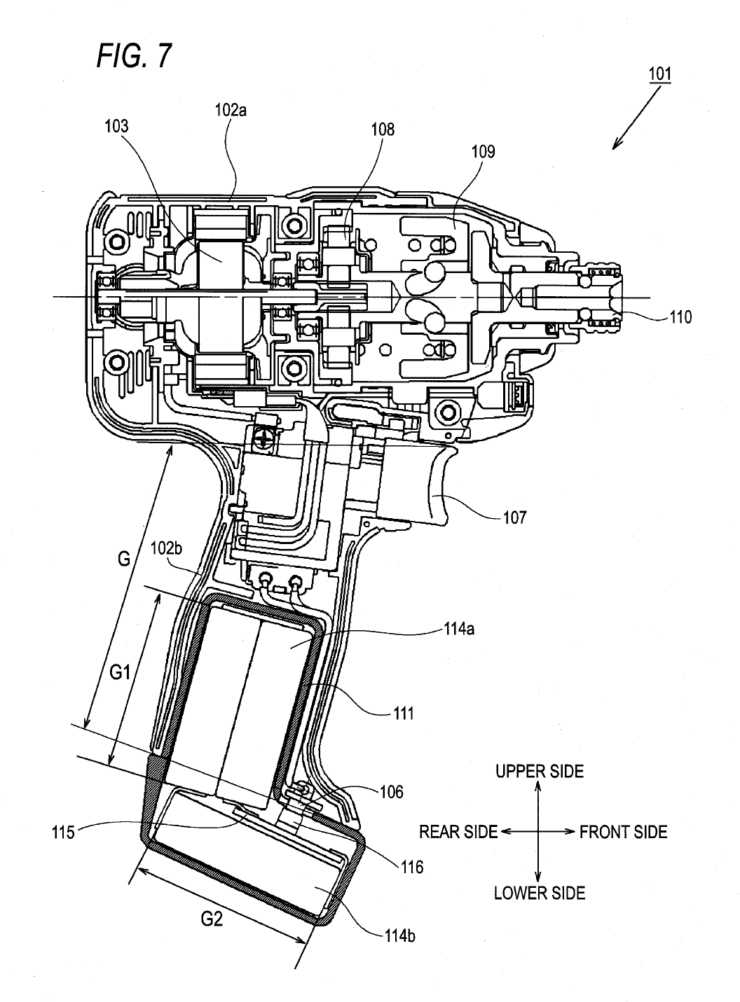

Now, a fifth exemplary embodiment of the present invention will be described with reference to FIG. 7. In the power tool 1, 21, 41, or 61 described with respect to the first to fourth exemplary embodiments, inside the housing 2, 22, 42, or 62, the motor which is a driving source, the trigger switch allowing the operator to manipulate the operation of the tool, and a power transmitting mechanism are provided. Further, the lithium-ion batteries 4, 24, 44, or 64 are accommodated inside the housing 2, 22, 42, or 62. Therefore, in order to exchange the lithium-ion batteries, it is necessary to disassemble the housing and perform an exchanging operation at a service center of the maker. The fifth exemplary embodiment is characterized by making lithium-ion batteries in a pack form such that the lithium-ion batteries are attachable to and detachable from the housing in a simple manner.

FIG. 7 is a longitudinal sectional view illustrating a configuration of a power tool (impact driver 101) according to the fifth exemplary embodiment of the present invention. In the impact driver 101, a motor 103 which is a driving unit, a trigger switch 107 allowing an operator to manipulate the operation of the tool, a gear unit 108, and a striking unit 109 are built in a housing 102 (102a and 102b), and an output shaft 110 for mounting or demounting a end tool (not shown) is provided at the end of the striking unit 109. Further, as shown in FIG. 7, a battery pack 111 having a roughly L shape in a side view is mounted such that a portion of a casing of the battery pack 111 enters the internal space of a grip portion 102b. In the battery pack 111, four lithium-ion batteries 114a are accommodated such that most portions thereof enter the internal space of the grip portion 102b, and two lithium-ion batteries 114b are accommodated below the grip portion 102b (the external space of the grip portion 102b).

Each cell of the lithium-ion batteries 114a and 114b has the 14500 size, and in the battery pack 111, a protection circuit for monitoring charging and discharging of the lithium-ion batteries 114a and 114b and protecting the lithium-ion batteries 114a and 114b is mounted on a protection circuit board 115. The protection circuit board 105 is provided at a lateral side of the lithium-ion batteries 114b. In this embodiment, the lateral side is a side that is closer to the lithium ion-batteries 114a, but is not limited thereto. Also, in a portion of the casing of the battery pack 111, at positions facing a plurality of terminals 106 positioned in the internal space of the grip portion 102b of the impact driver 101, a plurality of contact nodes 116 for supplying power to the impact driver 101 side are provided.

A main body of the impact driver 101 and the battery pack 111 are attachable to and detachable from each other, and a portion of the battery pack 111 enters the internal space of the grip portion 102b of the impact driver 101. A mechanism used in a known power tool may be used for a configuration of a latch mechanism for attaching or detaching the battery pack 111 to or from the grip portion 102b of the housing 102, and thus will not be described here in detail. In the present exemplary embodiment, the length of the grip portion 102b of the impact driver 101 (a range of a portion which the operator can grasp) is G, the length in the axis direction occupied by the cylindrical lithium-ion batteries 114a is G1, and the cylindrical lithium-ion batteries 114a are disposed such that most of the length G1 is included in the length G of the grip portion 102b. Also, the length in the axis direction occupied by the cylindrical lithium-ion batteries 114b is G2, and the cylindrical lithium-ion batteries 114b are disposed completely outside from the grip portion 102b. In the present exemplary embodiment, half or more of a volume ratio of 14500 type batteries is accommodated in the grip portion 102b, and less than half of the volume ratio is disposed outside the grip portion 102b. According to this configuration, it is possible to reduce the protruding amount (protruding volume) of the battery pack 111 protruding downward from the grip portion 102b, and to implement a user-friendly and compact power tool in which the shape of the lower portion of the grip portion 102b of the housing 102 is refined.

### Sixth Exemplary Embodiment

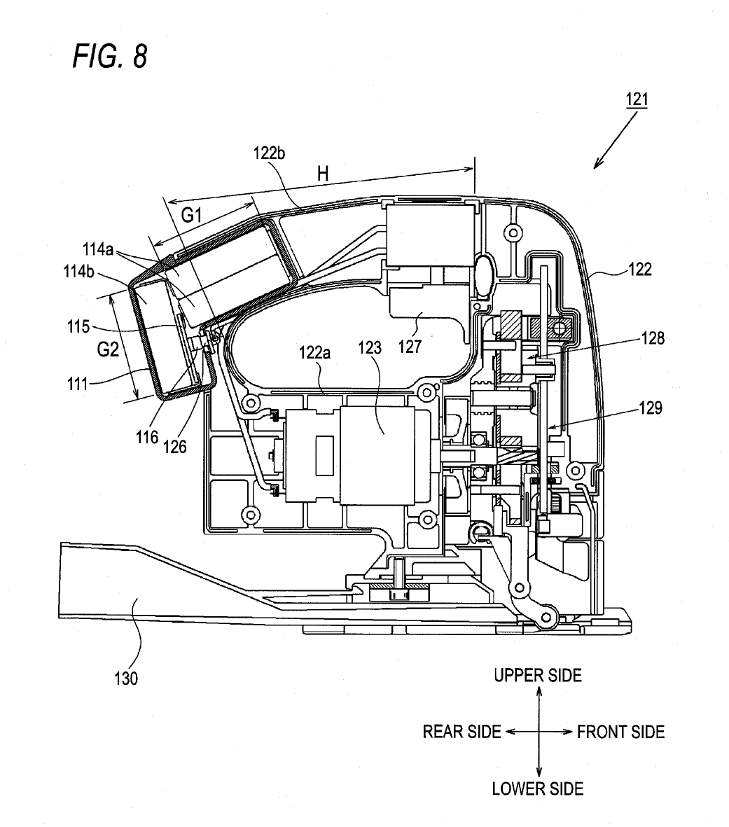

FIG. 8 is a longitudinal sectional view illustrating a configuration of a power tool (jigsaw 121) according to a sixth exemplary embodiment of the present invention. Unlike the jigsaw 21 shown in FIG. 3, the present exemplary embodiment is implemented by using the same one as the battery pack 111 shown in FIG. 7, without providing batteries inside a housing 122. In the battery pack 111, the lithium-ion batteries 114a and 114b having the 14500 size and a protection circuit board 115 are mounted. The mounting positions thereof are in the vicinity of an end portion of a grip portion 122b of the housing 122, and the battery pack 111 is attachable to and detachable from the housing 122. A motor 123 which is a driving unit is disposed in a motor accommodating portion 122a inside the housing 122 of the jigsaw 121, a trigger switch 127 allowing an operator to manipulate the operation of the tool is provided at the grip portion 122b, and a rotating mechanism unit 128 and a reciprocating mechanism unit 129 are provided in the front side of the housing 122 that connects the motor accommodating portion 122a and the grip portion 122b. At a lower portion of the housing, a base 130 is provided.

In the present exemplary embodiment, a portion of the battery pack 111 is disposed to enter the internal space of the grip portion 122b of the jigsaw 121. The length of the grip portion 122b of the jigsaw 121 (a range of a portion which the operator can grasp) is H, the length in the axis direction occupied by the cylindrical lithium-ion batteries 114a is G1, and the cylindrical lithium-ion batteries 114a are disposed such that most of the length G1 is included within the length H of the grip portion 122b. Also, the length in the axis direction occupied by the cylindrical lithium-ion batteries 114b is G2, and the cylindrical lithium-ion batteries 114b are disposed completely outside from the grip portion 122b. In the present exemplary embodiment, half or more of a volume ratio of 14500 type batteries is accommodated in the grip portion 122b, and less than half of the volume ratio is disposed outside the grip portion 122b. According to this configuration, it is possible to reduce the protruding amount (protruding volume) of the battery pack 111 protruding toward the rear side from the grip portion 122b, and to implement a user-friendly and compact power tool in which the shape of the vicinity of the rear end of the grip portion 122b of the housing 122 is refined.

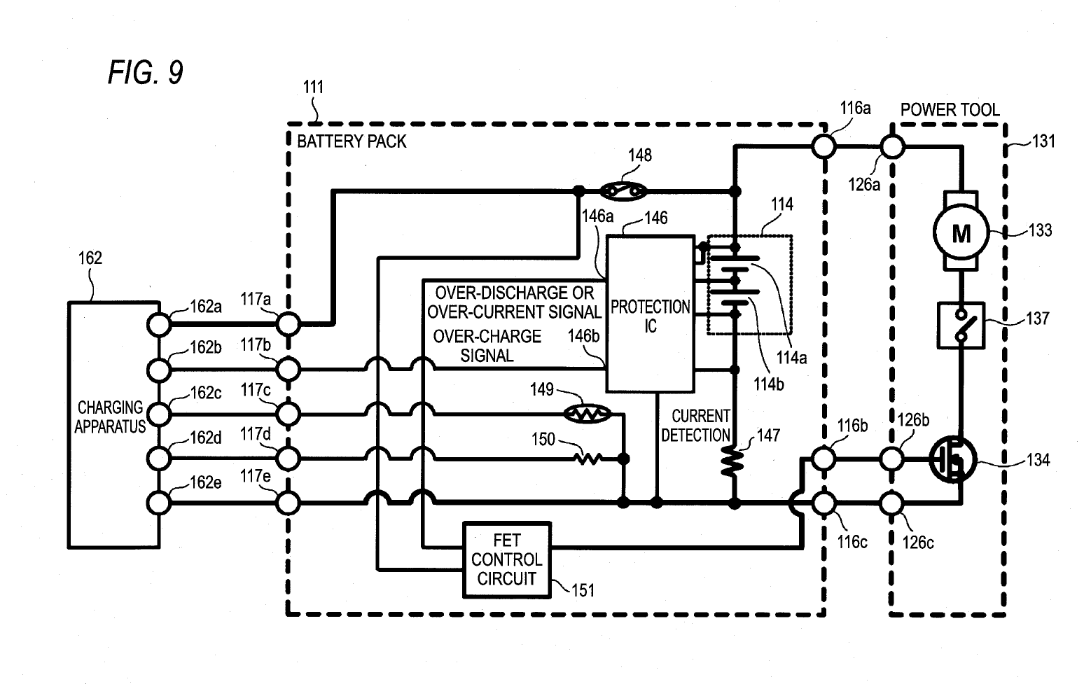

Now, a circuit block diagram regarding the power tools according to the fifth and sixth exemplary embodiments will be described with reference to FIG. 9. FIG. 9 shows a charging apparatus 162 which is prepared separately from a power tool 131 (such as the impact driver 101 or the jigsaw 121) and is for performing charging to a battery pack 111. In FIG. 9, three components of the charging apparatus 162, the battery pack 111, and the power tool 131 are shown as if they can be connected at the same time. However, actually, either connection between the charging apparatus 162 and the battery pack 111 or connection between the battery pack 111 and the power tool 131 can be performed, and it is not possible to connect the three components at the same time.

The charging apparatus 162 is configured to be attachable to and detachable from the battery pack 111 taken out of the power tool 131. If charging is necessary, the battery pack 111 is detached from the power tool 131, and is mounted to the charging apparatus 162, whereby charging is performed. In a case where the power tool 131 is used and in a case where charging is unnecessary, the battery pack is detached from the charging apparatus 162. A basic configuration of a protection circuit included inside the battery pack 111 is the same as that shown in FIG. 6, and is configured to include a protection IC 146, a FET control circuit 151, a thermal protector 148, a thermistor 149, and a determining resistor 150. In the battery pack 111, a battery set 114 is accommodated. In FIG. 9, only two cells of lithium-ion batteries 114a and 114b are shown. However, actually, an arbitrary combination of series connection or parallel connection of about 2 to 8 cells may be used.

In the present exemplary embodiment, a protection circuit for the batteries configured by the protection IC 146, the FET control circuit 151, and the like is accommodated inside the battery pack 111. As a result, on the power tool 131 side, it is only necessary to provide an FET 134 capable of ON or OFF control from the battery pack 111. Therefore, it is possible to simplify the configuration of the power tool 131 side.

The battery pack 111 is mounted in a housing of the power tool 131, whereby the battery pack 111 and the power tool 131 are attachable to and detachable from each other through contact nodes 116a, 116b, 116c and terminals 126a, 126b, and 126c. The contact node 116a and the terminal 126a are connected to the plus terminal of a motor 133 and the plus terminal of a battery set 114. The contact node 116b and the terminal 126b are connected to the FET 134 and the FET control circuit 151, and according to signals of this terminal, control to the FET 134 is performed. The contact node 116c and the terminal 126c are connected to the source of the FET 134 and the minus terminal of the battery set 114. Through the plus contact node 116a, the plus terminal 126a, the minus contact node 116c, and the minus terminal 126c, power is supplied from the battery set 114 to the motor 133.

The charging apparatus 162 is a device which uses a commercial AC power supply to supply power for charging the batteries to the power tool 131 side. The power tool 131 has terminals 117a to 117e, the charging apparatus 162 has terminals 162a to 162e, and between the terminals of the power tool 111 and the charging apparatus 162, the battery pack 111 is attached to the charging apparatus 162, whereby the battery pack 111 is electrically connected to the charging apparatus 162. The terminal 162a is connected to the plus terminal of the battery set 114 through the thermal protector 148. The terminal 162b is connected to an output terminal 146b of the protection IC 146 from which the ‘over-charge signal’ is output. The charging apparatus 162 detects the signal from the protection IC 146 through the terminal 162b, and stops supply of power for charging to the power tool 111 in a case of determining the over-charge state. The terminal 162c is connected to the thermistor 149, and the charging apparatus 162 detects the value of the thermistor 149 (that is, the current battery temperature), and adjusts a charging voltage or a charging current on the basis of the detected value (the battery temperature). The terminal 162d is connected to the determining resistor 150, and the charging apparatus 162 determines the kind of the battery set 114 (the number of series-connected lithium-ion batteries) from the detected voltage value, and performs control on charging on the basis of the determined battery kind. The terminal 162e is connected to the minus terminal of the battery set 114.

Although the present invention has been described on the basis of the exemplary embodiments, the present invention is not limited by the above-mentioned exemplary embodiments, but may be variously changed without departing from the scope of the present invention. For example, in the exemplary embodiments, as examples of the power tool, the impact drivers, the jigsaws, and the disc grinder have been described. However, the present invention is not limited thereto. The power tool may be any other cordless power tool.

The present invention provides illustrative, non-limiting aspects as follows:

(1) In a first aspect, there is provided a power tool including: a motor configured to be rotated by a lithium-ion secondary battery; an end tool configured to be driven by the rotation of the motor; and a switch configured to cause power to be supplied from the lithium-ion secondary battery to the motor when being manipulated by an operator, wherein the lithium-ion secondary battery includes a cell having a 14500 size and is configured to rotate the motor such that an output of the motor is sufficient for driving the end tool.

According to the first aspect, the lithium-ion secondary battery includes a cell having the 14500 size and is configured to rotate the motor such that an output of the motor is sufficient for driving the end tool. Therefore, it is possible to provide a small and light power tool using a small and light lithium-ion battery to a user.

(2) In a second aspect, there is provided the power tool according to the first aspect, wherein the cell having the 14500 size has a cylindrical shape having a diameter of 14 mm and a height of 50 mm.

(3) In a third aspect, there is provided the power tool according to the first aspect, wherein the lithium-ion secondary battery includes one or more cells having the 14500 size.

According to the third aspect, it is possible to obtain a necessary voltage while using small cells and to implement a power tool having sufficient output.

(4) In a fourth aspect, there is provided the power tool according to the third aspect, wherein the lithium-ion secondary battery includes a plurality of cells having the 14500 size, which are connected to each other by at least one of in series or in parallel.

According to the fourth aspect, it is possible to implement a power supply having arbitrary capacity according to a required specification.

(5) In a fifth aspect, there is provided the power tool according to any one of the first to fourth aspects, further including a battery-voltage detecting unit configured to detect a voltage which is supplied from the lithium-ion secondary battery to the motor, wherein if the detected voltage is a predetermined value or less, the power supply from the lithium-ion secondary battery to the motor is cut off.

According to the fifth aspect, it is possible to prevent over-discharge of the battery, and to prevent the life of the battery from being reduced.

(6) In a sixth aspect, there is provided the power tool according to the fifth aspect, wherein if the lithium-ion secondary battery includes a plurality of cells, the battery-voltage detecting unit also detects voltage of each cell, and if the voltage of at least one of the cells is a predetermined value or less, the battery-voltage detecting unit cuts off the power supply from the lithium-ion secondary battery to the motor.

According to the sixth aspect, it is possible to prevent over-discharge of a specific cell, and to prevent the life of the battery from being reduced.

(7) In a seventh aspect, there is provide the power tool according to the sixth aspect, further including: a connection terminal to which a charging apparatus for charging the lithium-ion secondary battery is configured to be connected; and a battery-voltage detecting unit configured to detect a voltage of the lithium-ion secondary battery during charging, wherein if the voltage of the lithium-ion secondary battery is a predetermined value or more, the charging is terminated.

According to the seventh aspect, it is possible to prevent over-charge, and to prevent the life of the battery from being reduced.

(8) In an eighth aspect, there is provided the power tool according to the seventh aspect, wherein if the lithium-ion secondary battery includes a plurality of cells, the battery-voltage detecting unit also detects the voltage of each cell, and if the voltage of at least one of the plurality of cells is a predetermined value or more, the charging is terminated.

According to the eighth aspect, it is possible to prevent only a specific cell from being deteriorated and to prevent the life of the battery from being reduced.

(9) In an ninth aspect, there is provided the power tool according to any one of the first to eighth aspects, further including a current detecting unit configured to detect a current which is supplied from the lithium-ion secondary battery to the motor; wherein if the detected current value is larger than a predetermined value, the current detecting unit cuts connection between the lithium-ion secondary battery and the motor.

According to the ninth aspect, it is possible to prevent a reduction in the life of the battery and damage to the motor attributable to excessively large current.

(10) In a tenth aspect, there is provided the power tool according to any one of the first to ninth aspects, further including a battery-temperature detecting unit configured to detect a temperature in the vicinity of the lithium-ion secondary battery, wherein if the temperature detected by the battery-temperature detecting unit is a predetermined value or more, connection between the lithium-ion secondary battery and the motor or the charging apparatus is cut.

According to a tenth aspect, it is possible to effectively prevent damage or a reduction in the life attributable to an excessive temperature of the battery.

(11) In an eleventh aspect, there is provided the power tool according to the first aspect, further including a protection circuit board configured to monitor at least one of charging and discharging of the lithium-ion secondary battery and protect the lithium-ion secondary battery, wherein the protection circuit board is disposed at an outer side of the lithium-ion secondary battery in a radial direction of the lithium-ion secondary battery.

According to the eleventh aspect, since the battery is smaller than that of the related-art, it is possible to dispose the protection circuit board at an outer side of the battery without making the grip portion large.

(12) In a twelfth aspect, there is provided the power tool according to the eleventh aspect, wherein the protection circuit board is disposed substantially parallel to the lithium-ion secondary battery.

(13) In a thirteenth aspect, there is provided the power tool according to the eleventh aspect, wherein a length of the protection circuit board is shorter than a length of the lithium-ion secondary battery in a longitudinal direction thereof.

According to the thirteenth aspect, it is possible to prevent the grip portion from becoming long.

(14) In a fourteenth aspect, there is provided the power tool according to the eleventh aspect, further including a socket configured to be connected with an external apparatus, wherein the socket is disposed lower to the lithium-ion secondary battery.

According to the fourteenth aspect, it is possible to prevent the diameter of the grip portion from becoming large.

(15) In a fifteenth aspect, there is provided the power tool according to the fourteenth aspect, wherein a width of the socket is shorter than a length of the lithium-ion secondary battery in the radial direction thereof.

According to the fifteenth aspect, it is possible to prevent the diameter of the grip portion from becoming large.

(16) In a sixteenth aspect, there is provided the power tool according to the first aspect, further including a protection circuit board configured to monitor at least one of charging and discharging of the lithium-ion secondary battery and protect the lithium-ion secondary battery, wherein the protection circuit board is disposed at an extension of the lithium-ion secondary battery in a longitudinal direction thereof.

According to the sixteenth aspect, since a diameter of the grip portion can be determined by a diameter of the battery, it is possible to prevent the diameter of the grip portion from becoming large.

(17) In a seventeenth aspect, there is provided the power tool according to the sixteenth aspect wherein a length of the protection circuit board is shorter than a length of the lithium-ion secondary battery in a radial direction thereof.

According to the seventeenth aspect, since a diameter of the grip portion can be determined by a diameter of the battery, it is possible to prevent the diameter of the grip portion from becoming large.

(18) In an eighteenth aspect, there is provided the power tool according to the first aspect, further including: a grip portion configured to be gripped by an operator; and a motor accommodating portion that accommodates the motor, wherein the lithium-ion secondary battery includes a first battery which is disposed at the grip portion and a second battery which is disposed at the motor accommodating portion.

According to the eighteenth aspect, since the battery is not disposed at single place, it is possible to prevent a portion to which the battery is disposed from becoming large.

(19) In a nineteenth aspect, there is provided the power tool according to the eighteenth aspect, wherein the lithium-ion secondary battery includes a plurality of cells having the 14500 size, and wherein a number of the cells configuring the first battery is smaller than a number of the cells configuring the second battery.

According to the nineteenth aspect, it is possible to prevent the grip portion from becoming large.

(20) In a twentieth aspect, there is provided the power tool according to the eighteenth aspect, further including a protection circuit board configured to monitor at least one of charging and discharging of the lithium-ion secondary battery and protect the lithium-ion secondary battery, wherein the protection circuit board is disposed at a connection portion that connects the grip portion and the motor accommodating portion.

According to the twentieth aspect, it is possible to effectively use the space inside the housing, thereby preventing the housing from becoming large. Further, since the protection circuit board is disposed between the grip portion and the motor accommodating portion, it is possible to make the wire from each battery short, thereby suppressing breaking of the wire.

(21) In a twenty-first aspect, there is provided the power tool according to the sixteenth aspect, wherein the protection circuit board is disposed substantially parallel to the lithium-ion secondary battery.

According to the twenty-first aspect, since a diameter of the grip portion can be determined by a diameter of the battery, it is possible to prevent the diameter of the grip portion from becoming large.

(22) In a twenty-second aspect, there is provided the power tool according to the twenty-first aspect, wherein the switch is disposed at an extension of the lithium-ion secondary battery in a longitudinal direction thereof and overlaps with the protection circuit board in a radial direction of the lithium-ion secondary battery.

According to the twenty-second aspect, it is possible to prevent the length and the diameter of the grip portion from becoming large.

(23) In a twenty-third aspect, there is provided a power tool including: a housing; a lithium-ion secondary battery accommodated in the housing; a motor configured to be rotated by the lithium-ion secondary battery; an end tool configured to be driven by the rotation of the motor; and a switch configured to cause power to be supplied from the lithium-ion secondary battery to the motor when being manipulated by an operator, wherein the lithium-ion secondary battery includes a cell having a 14500 size and is configured to rotate the motor such that an output of the motor is sufficient for driving the end tool.

According to the twenty-third aspect, in the power tool using the lithium-ion secondary battery as a power supply, the cell having the 14500 size is accommodated inside the housing. Therefore, it is possible to prevent the battery accommodating portion from protruding to the outside of the housing and to implement a small and user-friendly power tool having a refined appearance.

(24) In a twenty-fourth aspect, there is provided the power tool according to the twenty-third aspect, wherein the housing includes a grip portion allowing the operator to grasp the power tool, and wherein the lithium-ion secondary battery is disposed inside of the grip portion.

According to the twenty-fourth aspect, it is possible to implement a power tool having a good weight balance by concentrating a relatively heavy battery in the grip portion.

(25) In a twenty-fifth aspect, there is provided the power tool according to the twenty-third or twenty-fourth aspect, wherein a connection terminal to which a charging apparatus for supplying charging power to the lithium-ion secondary battery is configured to be connected is provided at a portion of the housing.

According to the twenty-fifth aspect, it is possible to easily charge the battery.

(26) In a twenty-sixth aspect, there is provided a power tool including: a housing; a motor configured to be rotated by a lithium-ion secondary battery; an end tool configured to be driven by the rotation of the motor; and a switch configured to cause power to be supplied from the lithium-ion secondary battery to the motor when being manipulated by an operator; wherein the lithium-ion secondary battery includes a cell having a 14500 size and is configured to rotate the motor such that an output of the motor is sufficient for driving the end tool, and wherein the lithium-ion secondary battery is configured in a battery pack which is attachable to and detachable from the housing of the power tool.

According to the twenty-sixth aspect, the power tool includes the battery pack including a cell having the 14500 size. Therefore, it is possible to implement a small and light power tool having a very compact battery pack.

(27) In a twenty-seventh aspect, there is provided the power tool according to the twenty-sixth aspect, wherein the housing includes a grip portion allowing the operator to grasp the power tool, and wherein the battery pack is mounted to the housing such that half or more of a volume thereof is accommodated in an internal space of the grip portion.

According to the twenty-seventh aspect, it is possible to implement a compact and user-friendly power tool in which the protruding portion from the housing is small.

(28) In a twenty-eighth aspect, there is provided the power tool according to the twenty-sixth aspect, wherein the housing includes a receiving portion configured to receive the battery pack.

(29) In a twenty-ninth aspect, there is provided the power tool according to the twenty-sixth aspect, further including a protection circuit board configured to monitor at least one of charging and discharging of the lithium-ion secondary battery and protect the lithium-ion secondary battery, wherein the housing includes a grip portion allowing the operator to grasp the power tool, and wherein the protection circuit board is disposed at a lateral side of a portion of the lithium-ion secondary battery which is disposed outside of the grip portion.

According to the twenty-ninth aspect, since the protection circuit board is disposed outside of the grip portion, it is possible to prevent the diameter of the grip portion from becoming large.

(30) In a thirtieth aspect, there is provided the battery pack according to the twenty-ninth aspect, wherein the lateral side of the portion of the lithium-ion secondary battery which is disposed outside of the grip portion is a lateral side closer to a portion of the lithium-ion secondary battery which is disposed inside of the grip portion.

According to the thirtieth aspect, since the protection circuit board is disposed between the battery inside of the grip portion and the outside of the grip portion, it is possible to make the wiring simple. Further, it is possible to protect the protection circuit board from impact by the grip portion and the battery.

What is claimed is:

1. A power tool comprising:
a motor configured to be rotated by a lithium-ion secondary battery;
an end tool configured to be driven by the rotation of the motor; and
a switch configured to cause power to be supplied from the lithium-ion secondary battery to the motor when being manipulated by an operator,
wherein the lithium-ion secondary battery includes a cell having a 14500 size and is configured to rotate the motor such that an output of the motor is sufficient for driving the end tool.

2. The power tool according to claim 1,
wherein the cell having the 14500 size has a cylindrical shape having a diameter of 14 mm and a height of 50 mm.

3. The power tool according to claim 1,
wherein the lithium-ion secondary battery includes one or more cells having the 14500 size.

4. The power tool according to claim 3,
wherein the lithium-ion secondary battery includes a plurality of cells having the 14500 size, which are connected to each other by at least one of in series or in parallel.

5. The power tool according to claim 1, further comprising a battery-voltage detecting unit configured to detect a voltage which is supplied from the lithium-ion secondary battery to the motor,
wherein if the detected voltage is a predetermined value or less, the power supply from the lithium-ion secondary battery to the motor is cut off.

6. The power tool according to claim 5,
wherein if the lithium-ion secondary battery includes a plurality of cells, the battery-voltage detecting unit also detects voltage of each cell, and if the voltage of at least one of the cells is a predetermined value or less, the battery-voltage detecting unit cuts off the power supply from the lithium-ion secondary battery to the motor.

7. The power tool according to claim 6, further comprising:
a connection terminal to which a charging apparatus for charging the lithium-ion secondary battery is configured to be connected; and
a battery-voltage detecting unit configured to detect a voltage of the lithium-ion secondary battery during charging,
wherein if the voltage of the lithium-ion secondary battery is a predetermined value or more, the charging is terminated.

8. The power tool according to claim 7,
wherein if the lithium-ion secondary battery includes a plurality of cells, the battery-voltage detecting unit also detects the voltage of each cell, and if the voltage of at least one of the plurality of cells is a predetermined value or more, the charging is terminated.

9. The power tool according to claim 1, further comprising a current detecting unit configured to detect a current which is supplied from the lithium-ion secondary battery to the motor;
wherein if the detected current value is larger than a predetermined value, the current detecting unit cuts connection between the lithium-ion secondary battery and the motor.

10. The power tool according to claim 1, further comprising a battery-temperature detecting unit configured to detect a temperature in the vicinity of the lithium-ion secondary battery,
wherein if the temperature detected by the battery-temperature detecting unit is a predetermined value or more, connection between the lithium-ion secondary battery and the motor or the charging apparatus is cut.

11. The power tool according to claim 1, further comprising a protection circuit board configured to monitor at least one of charging and discharging of the lithium-ion secondary battery and protect the lithium-ion secondary battery,
wherein the protection circuit board is disposed at an outer side of the lithium-ion secondary battery in a radial direction of the lithium-ion secondary battery.

12. The power tool according to claim 11,
wherein the protection circuit board is disposed substantially parallel to the lithium-ion secondary battery.

13. The power tool according to claim 11,
wherein a length of the protection circuit board is shorter than a length of the lithium-ion secondary battery in a longitudinal direction thereof.

14. The power tool according to claim 11, further comprising a socket configured to be connected with an external apparatus,
wherein the socket is disposed lower to the lithium-ion secondary battery.

15. The power tool according to claim 14,
wherein a width of the socket is shorter than a length of the lithium-ion secondary battery in the radial direction thereof.

16. The power tool according to claim 1, further comprising a protection circuit board configured to monitor at least one of charging and discharging of the lithium-ion secondary battery and protect the lithium-ion secondary battery,
wherein the protection circuit board is disposed at an extension of the lithium-ion secondary battery in a longitudinal direction thereof.

17. The power tool according to claim 16,
wherein a length of the protection circuit board is shorter than a length of the lithium-ion secondary battery in a radial direction thereof.

18. The power tool according to claim 1, further comprising:
a grip portion configured to be gripped by an operator; and
a motor accommodating portion that accommodates the motor,
wherein the lithium-ion secondary battery includes a first battery which is disposed at the grip portion and a second battery which is disposed at the motor accommodating portion.

19. The power tool according to claim 18,
wherein the lithium-ion secondary battery includes a plurality of cells having the 14500 size, and
wherein a number of the cells configuring the first battery is smaller than a number of the cells configuring the second battery.

20. The power tool according to claim 18, further comprising a protection circuit board configured to monitor at least one of charging and discharging of the lithium-ion secondary battery and protect the lithium-ion secondary battery,
wherein the protection circuit board is disposed at a connection portion that connects the grip portion and the motor accommodating portion.

21. The power tool according to claim 16,
wherein the protection circuit board is disposed substantially parallel to the lithium-ion secondary battery.

22. The power tool according to claim 21,
wherein the switch is disposed at an extension of the lithium-ion secondary battery in a longitudinal direction thereof and overlaps with the protection circuit board in a radial direction of the lithium-ion secondary battery.

23. A power tool comprising:
a housing;
a lithium-ion secondary battery accommodated in the housing;
a motor configured to be rotated by the lithium-ion secondary battery;
an end tool configured to be driven by the rotation of the motor; and,
a switch configured to cause power to be supplied from the lithium-ion secondary battery to the motor when being manipulated by an operator,
wherein the lithium-ion secondary battery includes a cell having a 14500 size and is configured to rotate the motor such that an output of the motor is sufficient for driving the end tool.

24. The power tool according to claim 23,
wherein the housing includes a grip portion allowing the operator to grasp the power tool, and
wherein the lithium-ion secondary battery is disposed inside of the grip portion.

25. The power tool according to claim 23,
wherein a connection terminal to which a charging apparatus for supplying charging power to the lithium-ion secondary battery is configured to be connected is provided at a portion of the housing.

26. A power tool comprising:
a housing;
a motor configured to be rotated by a lithium-ion secondary battery;
an end tool configured to be driven by the rotation of the motor; and
a switch configured to cause power to be supplied from the lithium-ion secondary battery to the motor when being manipulated by an operator;
wherein the lithium-ion secondary battery includes a cell having a 14500 size and is configured to rotate the motor such that an output of the motor is sufficient for driving the end tool, and
wherein the lithium-ion secondary battery is configured in a battery pack which is attachable to and detachable from the housing of the power tool.

27. The power tool according to claim 26,
wherein the housing includes a grip portion allowing the operator to grasp the power tool, and
wherein the battery pack is mounted to the housing such that half or more of a volume thereof is accommodated in an internal space of the grip portion.

28. The power tool according to claim 26,
wherein the housing includes a receiving portion configured to receive the battery pack.

29. The power tool according to claim 26, further comprising a protection circuit board configured to monitor at least one of charging and discharging of the lithium-ion secondary battery and protect the lithium-ion secondary battery,
wherein the housing includes a grip portion allowing the operator to grasp the power tool, and
wherein the protection circuit board is disposed at a lateral side of a portion of the lithium-ion secondary battery which is disposed outside of the grip portion.

30. The battery pack according to claim 29,
wherein the lateral side of the portion of the lithium-ion secondary battery which is disposed outside of the grip portion is a lateral side closer to a portion of the lithium-ion secondary battery which is disposed inside of the grip portion.
